(19) United States
(12) Patent Application Publication
(10) Pub. No.: US 2024/0015386 A1
(43) Pub. Date: Jan. 11, 2024

(54) SYSTEM AND METHOD FOR MONITORING AND TRACKING ANIMALS IN ANIMAL ENCLOSURES

(71) Applicants: Sami Dalati, Toronto (CA); Kaicheng Zhang, Markham (CA)

(72) Inventors: Sami Dalati, Toronto (CA); Kaicheng Zhang, Markham (CA)

(21) Appl. No.: 18/348,711

(22) Filed: Jul. 7, 2023

Related U.S. Application Data
(60) Provisional application No. 63/359,322, filed on Jul. 8, 2022.

(51) Int. Cl. H04N 23/62; H04N 23/695; H04N 23/67; G06V 10/70; G06V 40/10; H04N 23/661; G06V 20/50

(52) U.S. Cl. CPC H04N 23/62; H04N 23/695; H04N 23/67; G06V 10/70; G06V 40/10; H04N 23/661; G06V 20/50

(57) ABSTRACT

Embodiments herein generally relate to a method and system for monitoring and tracking animals in an animal enclosure. In at least one embodiment, the method comprises monitoring for user activity in respect of a camera system associated with the animal enclosure; if user activity is detected: receiving a user-generated command to control the camera; and transmitting the user-generated command to the camera system, if user activity is not detected, controlling the camera system to search and track for one or more target animals in the animal enclosure.

### CROSS REFERENCE TO RELATED APPLICATIONS

This application claims the benefit of U.S. Provisional Patent Application Ser. No. 63/359,322, filed Jul. 8, 2022, the entire contents of which are hereby incorporated by reference.

### FIELD

The present disclosure relates to monitoring and tracking systems, and in particular, to a method and system for monitoring and tracking animals in animal enclosures.

### INTRODUCTION

The following is not an admission that anything discussed below is part of the prior art or part of the common general knowledge of a person skilled in the art.

Animal enclosure facilities (e.g., zoos) are often frequented by individuals desiring to more closely observe animals and other wildlife. Observing animals and wildlife in this manner, however, requires individuals to be physically attendant at the animal enclosure facility. Furthermore, animals are only observable during times and days when the facility is open for public visitation.

In recent years, live camera streaming services have seen an increasing rate of adoption in many animal facilities. In particular, these services allow individuals to more closely monitor animals from remote locations (e.g., the individuals' homes), and at any time of day.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In one broad aspect, there is provided method for monitoring and tracking animals in an animal enclosure, comprising: monitoring for user activity in respect of a camera system associated with the animal enclosure; if user activity is detected: receiving a user-generated command to control the camera; and transmitting the user-generated command to the camera system, if user activity is not detected, controlling the camera system to search and track for one or more target animals in the animal enclosure.

In at least one example, controlling the camera system to search and track for the one or more target animals comprises: controlling the camera system according to a pre-determined scanning pattern; receiving one or more image frames from the camera system; applying an animal-specific machine learning detection model to the one or more image frames; determining whether the target animal was detected in at least one, of the one or more image frames; and controlling the camera system to focus on the target animal.

In at least one example, the method further comprises, initially, selecting the animal-specific machine learning model based one or more model selection factors.

In at least one example, determining target pixel coordinates for the target animal in the at least on image frame, and determining camera configuration settings for focusing on the target pixel coordinates.

In at least one example, the user-generated commands include target pixel coordinates, and the method further comprises: determining camera configuration settings for focusing on the target pixel coordinates; and transmitting a control signal to the camera system comprising the camera configuration settings.

In at least one example, the camera configuration settings include one or more of a pan angle, a tilt angle and a zoom angle.

In at least one example, the method further comprises, initially: determining a number of user device connections with the camera system; determining a pre-defined voting window time period; opening a voting window for the pre-defined time period; receiving user-generated commands from each user device; generating a combined output command based on the user-generated commands.

In at least one example, the combined output command is generated by determine one of an average and a mean of the target pixel coordinates in each of the user-generated commands.

In at least one example, the camera system comprises a camera controller coupled to a pan-tilt-zoom (PTZ) camera devices.

In another broad aspect there is provided a system for monitoring and tracking animals in an animal enclosure, the system comprising at least one processor for executing the method comprising: monitoring for user activity in respect of a camera system associated with the animal enclosure; if user activity is detected: receiving a user-generated command to control the camera; and transmitting the user-generated command to the camera system, if user activity is not detected, controlling the camera system to search and track for one or more target animals in the animal enclosure.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is an example system for monitoring and tracking animals in an animal enclosure;

FIG. 1B is another example system for tracking animals in an animal enclosure;

FIG. 2 are various schematic illustrations of camera systems installed in various example animal enclosures;

FIG. 3A is a process flow for an example method of communication between a user device 102, a server 106 and a camera system 104;

FIG. 3B is a process flow for an example method for controlling a camera system by multiple user devices;

FIG. 4A is a process flow for an example method for operating a camera system;

FIG. 4B is a process flow for an example method for searching and tracking of a target animal located within an animal enclosure;

FIG. 4C is a process flow for an example method for searching and detecting a target animal located within an animal enclosure;

FIG. 4D is a process flow for an example method for converting target image pixel coordinates to camera system motion control commands;

FIG. 4E is a process flow for an example method for generating a zoom-specific angle of view (AoV) profile for a given camera system;

FIG. 5A is an illustration of an example user device displaying a live media stream of an animal enclosure;

FIG. 5B is an illustration of an example user device displaying a live media stream of an animal enclosure;

FIG. 6 is an illustration of an example scanning process, for a camera system, for searching for a target animal within an animal enclosure;

FIG. 7A is a schematic illustration of a camera device disposed in an initial position state;

FIG. 7B is an example image frame generated by the camera device in the initial position state of FIG. 7A;

FIG. 7C is a schematic illustration of the camera device, of FIG. 7A, panning to a rotated position state;

FIG. 7D is an example image frame generated by the camera device in the rotated position state of FIG. 7B;

FIG. 7E is an example image frame generated by the camera device in the initial position state of FIG. 7A;

FIG. 8A is a process flow for an example method for training an animal-specific machine learning detection model;

FIG. 8B is a process flow for an example method for updating an animal-specific machine learning detection model;

FIG. 9A is a simplified hardware block diagram for an example user device;

FIG. 9B is a simplified hardware block diagram for an example server;

FIG. 10A is a screenshot of an example graphical user interface (GUI);

FIG. 10B is another screenshot of an example GUI;

FIG. 11A is an example simplified architecture for a YOLO network architecture; and

FIG. 11B is an example simplified architecture for a YOLOv5 network architecture.

Further aspects and features of the example embodiments described herein will appear from the following description taken together with the accompanying drawings.

### DETAILED DESCRIPTION

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

It should also be noted that the terms “coupled” or “coupling” as used herein can have several different meanings depending in the context in which these terms are used. For example, the terms coupled or coupling can have a mechanical, fluidic or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Exemplary communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The example systems and methods described herein may be implemented as a combination of hardware or software. In some cases, the examples described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

Some elements that are used to implement at least part of the systems, methods, and devices described herein may be implemented via software that is written in a high-level procedural language such as object-oriented programming. The program code may be written in C++, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having at least one processor, an operating system, and the associated hardware and software that is used to implement the functionality of at least one of the methods described herein. The software program code, when read by the device, configures the device to operate in a new, specific, and predefined manner (e.g., as a specific-purpose computer) in order to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

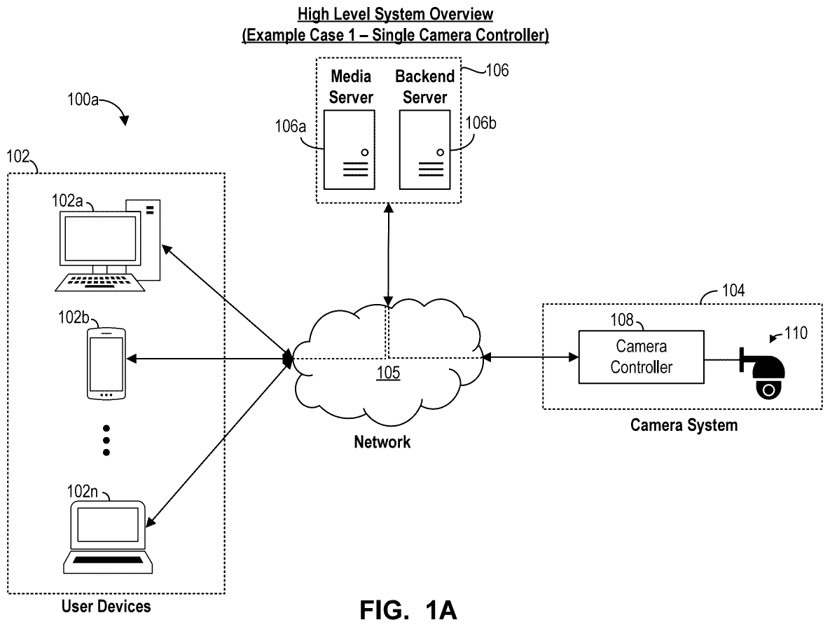

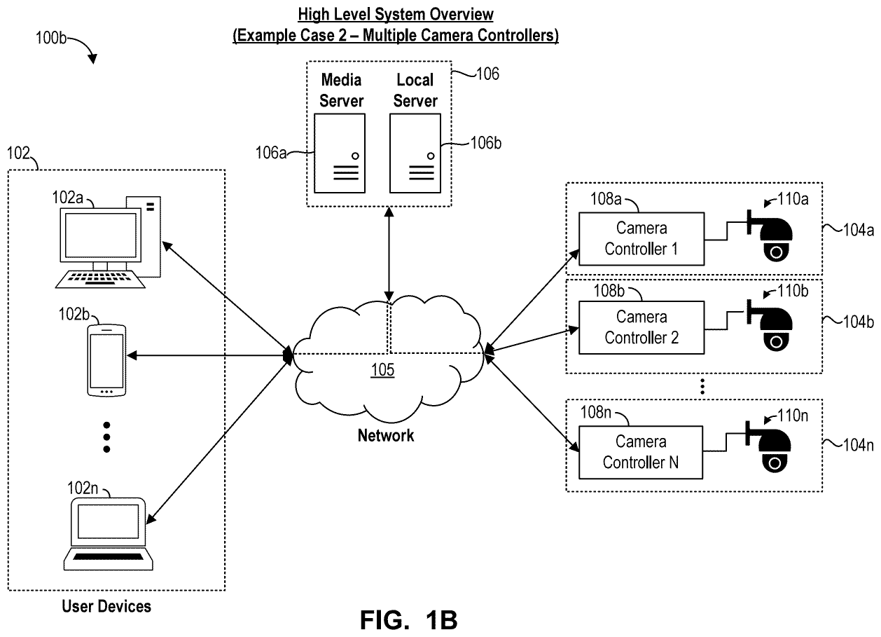

Reference is now made to FIG. 1A, which shows an example system 100a for monitoring and tracking animals in an animal enclosure.

As shown, system 100a generally includes one or more user devices 102a-102n in communication, via network 105, with at least one camera system 104 and one or more servers 106.

User devices 102 generally refer to desktop or laptop computers, but may also refer to smartphones, tablet computers, as well as a wide variety of “smart” devices capable of data communication, including “smart” television sets. User devices 120 may be portable or non-portable, and may at times be connected to network 105 or a portion thereof.

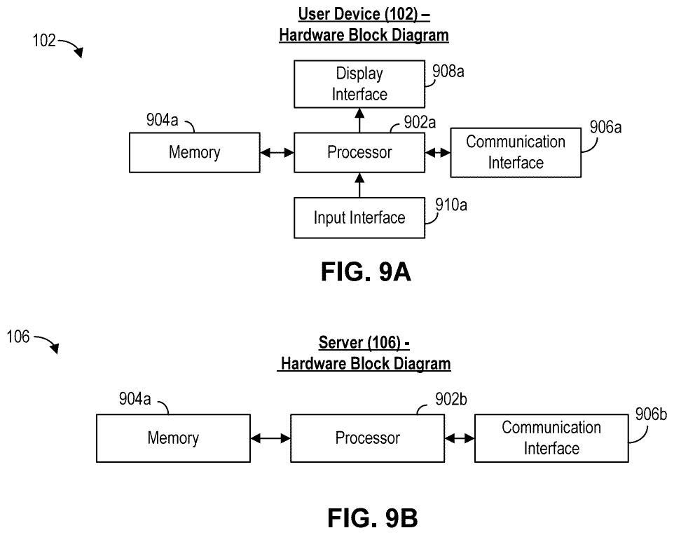

With reference to FIG. 9A, as explained in greater detail herein, each user device 102 may include one or more processors 902a coupled, via a data bus, to a volatile and/or non-volatile memory 904a, at least one communication interface 906a, a display interface 908a (e.g., an LCD screen or desktop monitor) and/or an input interface 910a (e.g., a mouse and keyboard, or a touch display screen).

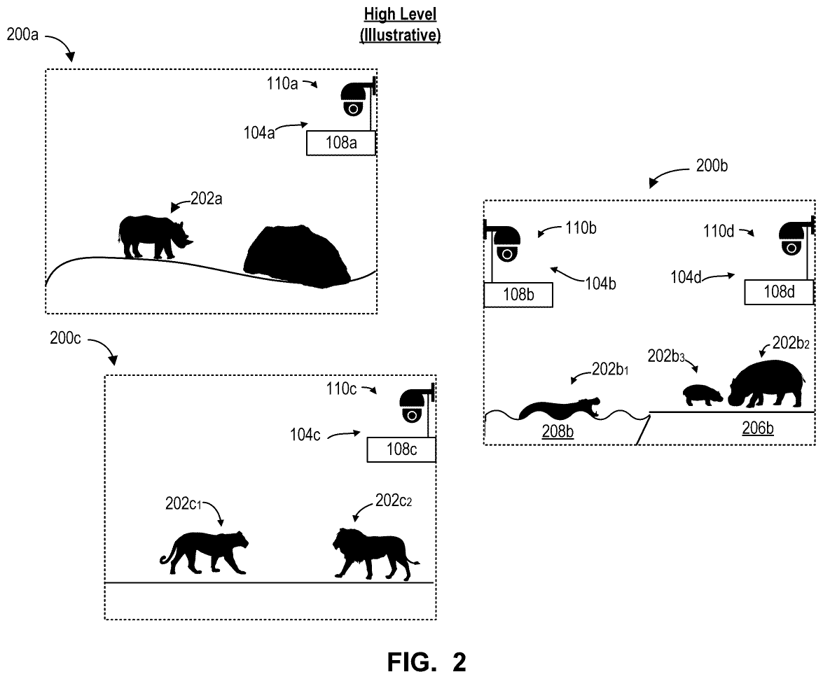

Referring back to FIG. 1A, camera system 104 may be used for monitoring an associated animal enclosure. For example, as shown in FIG. 2, a camera system 104 can be located inside—or otherwise installed proximal—an animal enclosure 200 housing various animal wildlife. By way of non-limiting examples, a camera system 104 may be installed inside of rhinoceros enclosure 200a, a hippopotamus enclosure 200b or a lion enclosure 200c.

In more detail, the camera system 104 may capture media, such as video streams or image frames of the associated animal enclosure. The media may be transmitted, or streamed back, to one or more of the user devices 102 (e.g., via media server 106a). Users, of users devices 102, may use the received media to remotely observe and monitor animals located within an associated animal enclosure 200. In some example cases, the camera system 104 may transmit real-time or near real-time (i.e., live) video streams of the animal enclosures to user devices 102. In other cases, the camera system 104 may transmit image frames at pre-defined time or frequency intervals.

Camera system 104 is also remotely controllable by user devices 102. For instance, in some example cases, users may input user-generated commands into their respective user devices 102. The user-generated commands can remotely adjust configuration settings of the camera system 104. The adjustable configuration settings can include, for example, the camera's positional settings (e.g., pan and tilt), as well as the camera's zoom settings. Adjusting the camera's positional settings allows users to observe different areas of an animal enclosure. Additionally, controlling the zoom setting may allow users to view features of the animal enclosure in greater or broader detail.

In some examples, camera system 104 may comprise a pan tilt unit (PTU) camera. In other examples, the camera system 104 may comprise a pan tilt zoom unit (PTZU).

To this end, the camera system 104 may include a camera controller 108 coupled to a camera device 110. Camera controller 108 can include, for example, one or more processors that are operably coupled to one or more motors (e.g., stepper motors) which control the positional setting of the camera device 110. Camera controller 108 may generate control signals to control the camera motors to vary the pan and tilt angle of the camera device. Camera controller 108 may additionally generate control signals to adjust a zoom level of the camera device 110.

Camera controller 108 can exist in various locations, relative to the camera device 110. For example, camera controller 108 can be coupled directly to the camera device 110, and in the same physical location. Camera controller 108 can also exist anywhere within the animal facility (e.g., zoo), insofar that it is connected to the same local network (or virtual network) as the camera device 110. In still other examples, camera controller 108 can be hosted on a remote cloud server, and accessed by camera device 110. In some examples, the camera controller 108 is hosted directly on the server 106.

In some cases, camera controller 108 can generate control signals responsive to received user-generated commands, e.g., from user devices 102. In other cases, the control signals are generated responsive to automated commands received, for example, from server 106. As provided herein, server 106 can generate automated commands to control the camera system 104. For example, the server commands can control the camera system 104 to search and track for target animals within associated animal enclosures. In examples where the camera controller 108 is hosted on the server 106, then the server 106/camera controller 108 can communicate directly with the camera device 110.

Camera device 110 may also transmit media back to the controller 108 (e.g., video and/or image frames). This media may be transmitted, via network 105, to one or more user devices 102 (e.g., via media server 106a). Again, in some examples where the camera controller 108 is hosted on server 106—the server 106 receives media directly from the camera device 110.

Camera device 110 may be operable in an infrared mode (IR mode). For example, when the camera device 110 does not detect sufficient light in the environment, an IR light may be turned automatically, or on-request. This may be advantageous when capturing media of animals in the dark (e.g., at night). The IR light may be provided internally or externally to the camera device 110, and can be controlled by the camera device 110 directly, and/or by the camera controller 108.

In system 100a, server 106 may act as the communication intermediary between the camera controller 104, and the one or more user devices 102. For example, user-generated commands—received from user devices 102—may be transmitted to the camera system 104 via server 106. Further, media generated by camera system 104 (e.g., live video feeds) may be transmitted back to user devices 102, via server 106. In other examples, server 106 hosts the camera controller 108, and therefore simply acts as the intermediary between the user devices 110, and the camera device 110.

In embodiments herein, server 106 can refer to one or more computer servers that are connected to network 105. That is, although server 106 is referred to herein in the singular, server 106 can in-fact include one or more servers 106 (e.g., a plurality of servers).

For instance, in one example, server 106 may include a media server 106a and a backend server 106b. Media server 106a (also referred to herein as a media streaming server) may transmit or stream media from camera system 104 (or camera device 110) to one or more user devices 102, connected to media server 106a.

On the other hand, backend server 106b can receive user-generated commands from user devices 102, and can control the camera system 104 based on these commands. For example, backend server 106b can host software for translating user-generated commands into camera movement and configuration commands (e.g., pan, tilt and zoom configuration settings). These commands can be transmitted to a camera controller 108, associated with a camera device 110.

In other cases, the camera controller 108 is hosted on the server, and therefore the server communicates the commands directly to the camera device 110. Backend server 106b can also host trained machine learning models which analyze media (e.g., image frames), generated by camera system 104, to identify target animals—and further, to automatically control the camera system 104 to focus and track these target animals. In some examples, these machine learning models are also hosted directly on the camera controller 108.

In other cases, system 100a may include only a single server which provides the combined function of the media and backend servers 106a, 106b. Accordingly, it will be understood that reference to server 106 herein may refer to any number of servers providing any combination or sub-combination of functions.

It will be further understood that the server 106 need not be a dedicated physical computer. For example, in at least some example cases, the various logical components that are shown as being provided on server 106 may be hosted by a third party “cloud” hosting service such as Amazon™ Web Services™ Elastic Compute Cloud (Amazon EC2).

With reference to FIG. 9B, each server 106 may include one or more processors 902b coupled, via a data bus, to a volatile and/or non-volatile memory 904b and at least one communication interface 906b.

In some example cases, the camera system 104 may also communicate directly with the user input devices 102, without the need for the server 106. For example, the function of the server 106 may be integrated directly into the camera controller 108.

Network 105 may be connected to the internet. Typically, the connection between network 105 and the Internet may be made via a firewall server (not shown). In some cases, there may be multiple links or firewalls, or both, between network 105 and the Internet. Some organizations may operate multiple networks 105 or virtual networks 105, which can be internetworked or isolated. These have been omitted for ease of illustration, however it will be understood that the teachings herein can be applied to such systems. Network 105 may be constructed from one or more computer network technologies, such as IEEE 802.3 (Ethernet), IEEE 802.11, IEEE 802.3af, IEEE 802.3at, IEEE 802.3bt (type 3 and 4) and similar technologies. In various cases, different parts of the network 105 may also be constructed from different computer network technologies.

Reference is now made concurrently to FIG. 1B, which shows another example system 100b for tracking animals in an animal enclosure.

System 100b is generally analogous to system 100a, with the exception that the system 100b now includes a plurality of camera systems 104a-104n. For example, each camera system 104 may be associated with a different or same animal enclosure.

For instance, as shown in FIG. 2, a first camera system 104a may be associated with a first animal enclosure 200a (e.g., a rhinoceros enclosure). A second camera system 104b may be associated with a second animal enclosure 200b (e.g., a hippopotamus enclosure). Further, a third camera system 104c may be associated with a third animal enclosure 200c (e.g., a lion enclosure). Accordingly, each camera system 104a-104c may monitor different animals located in different enclosures in the animal enclosure facility.

In some example cases, multiple camera systems 104 may also be associated with the same animal enclosure 200. For example, the hippopotamus enclosure 200b may be monitored by two or more camera systems 104b, 104d. Camera systems 104b, 104d can monitor different areas of the same enclosure 200, or different perspective angles of the same enclosure area.

As provided herein, system 100b may enable users—of respective user device 102—to select which camera system 104 to access and/or control. Accordingly, users can toggle between observing different animal enclosures in the same facility and/or toggle between observing different perspective views of the same enclosure.

While FIG. 1B illustrates a separate camera controller 108 in association with each camera device 110, in other examples the same camera controller 108 can be associated with multiple camera devices 110. For example, a single camera controller 108 can operate to transmit and receive signals from separate camera devices 110. Accordingly, in these examples, the camera systems 104 may be at least partially overlapping, in that they share a common camera controller 108.

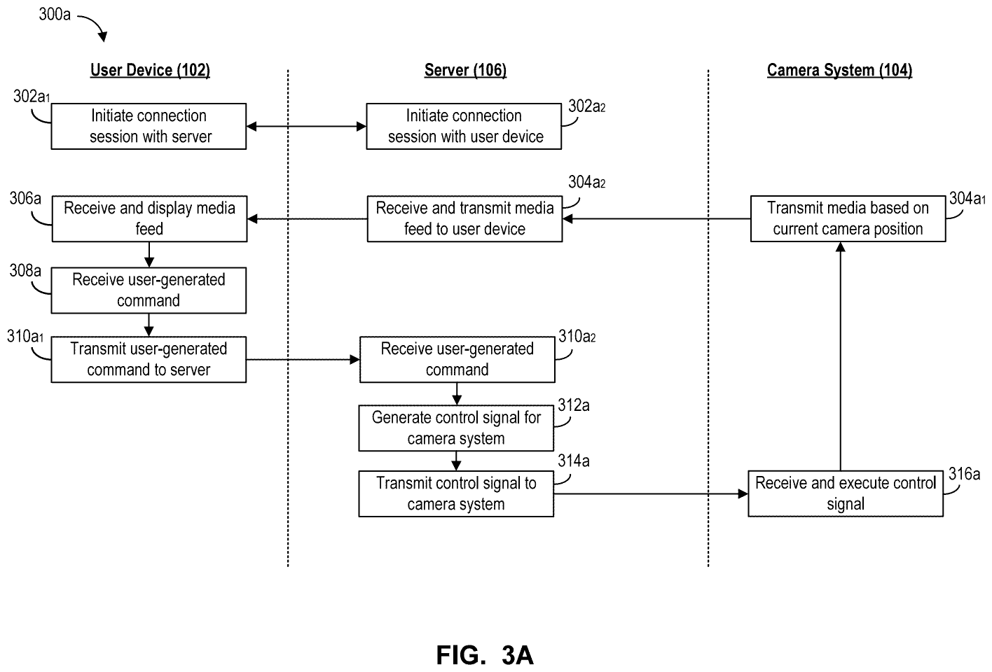

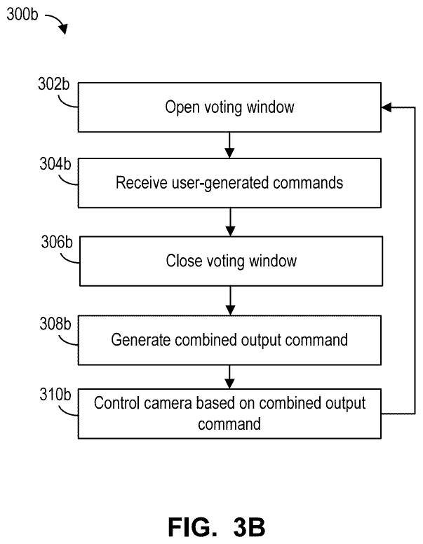

Reference is now made to FIG. 3A, which shows an example method 300a for communication between a user device 102, a server 106 and a camera system 104.

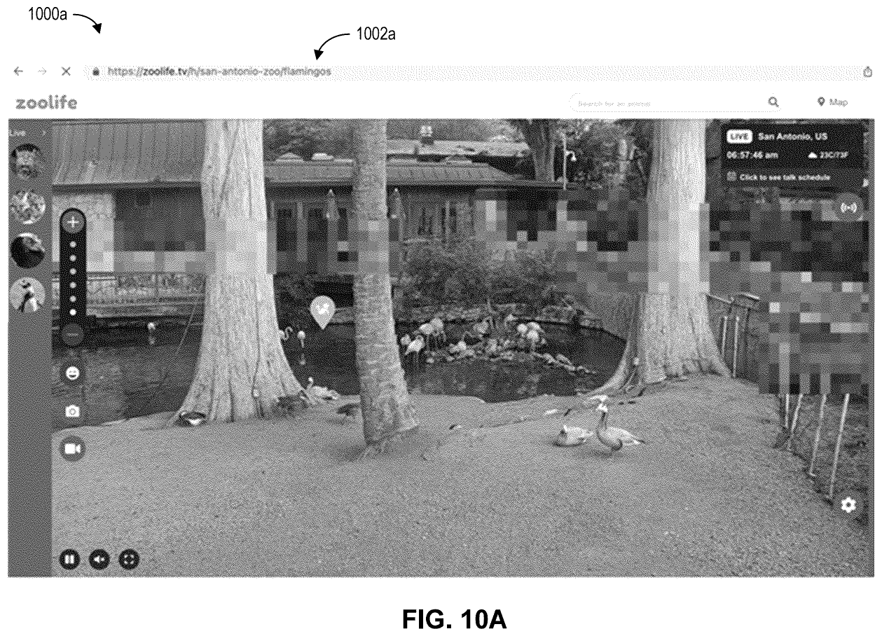

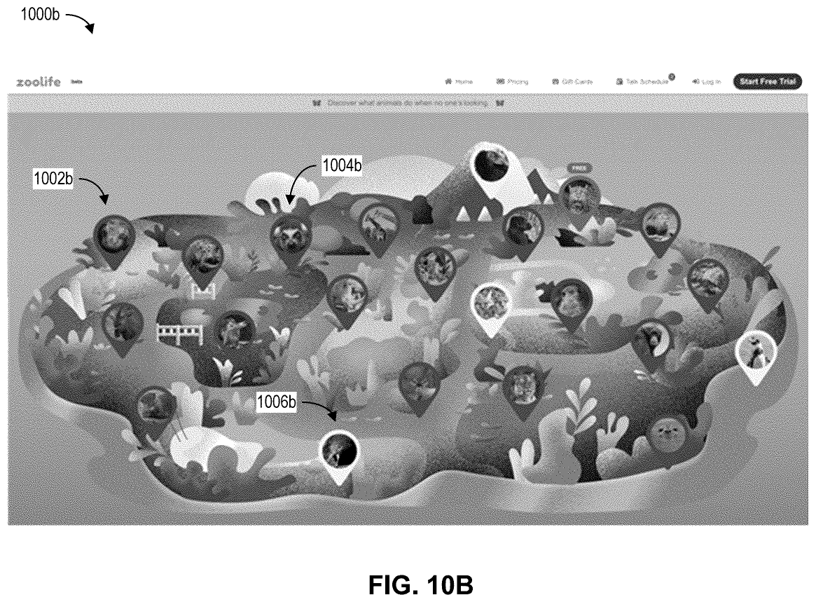

As shown, at 302a₁, a user device 102 may initiate a connection with the server 106. At 302a₂, the server 106 may also initiate a connection with the user device 102. In some example cases, the connection between the user device 102 and the server 106 may occur through a web interface accessible through a web browser software installed on the user device 102. For example, a user may enter a URL (Uniform Resource Locator) domain, in an internet browser, which instantiates a new connection session with the remote server 106 (see e.g., URL 1002a in screenshot 1002a, in FIG. 10A).

In response to the new connection, server 106 may transmit (e.g., stream) media from the camera system 104 to the user device 102. For example, the server 106 may receive video (or image frames) from a camera system 104 (304a₁). In some examples, it is the media server 106a which receives the video or image frames from the camera system 104. The media may show the current view of the camera system 104, based on the camera's current configuration settings (e.g., position and zoom). In turn, the server 106 (e.g., media server 106a) may transmit the media to the user device (304a₂). The media may then be displayed on the user device 102 (306a), e.g., via the device's display interface 908a (FIG. 9A).

In at least one example, at act 302a, the initial connection may occur between the user device 102 and the backend server 106b. The backend server 106b then returns media connection information to the user device 102. User device 102 uses the media connection to initiate a separate connection with the media server 106a, and receive video streams therefrom.

In some examples, more than one camera system 104 may be available in the system (FIG. 1B). In these examples, the user device 102 may also initially specify, to the server 106, which camera system 104 to access (i.e., at 302a₁). This request may be transmitted via the web interface displayed on user device 102. For example, the web interface may present a graphical user interface (GUI) with different enclosures the user can observe (see e.g., enclosures 1002b-1006b in screenshot 1002b, in FIG. 10B). The user may select a particular enclosure to observe and/or a particular camera system associated with an enclosure. In turn, server 106 may only transmit media from the selected camera system 104, and/or the camera system 104 associated with the selected animal enclosure. In some examples, the backend server 106b may also only return media connection information associated with the relevant camera systems 104.

At 308a, the user device 102 may receive a user-generated command from an associated user. The user-generated command may request adjusting the configuration settings of the accessed camera system 104. For example, this can include adjusting the positional settings of the respective camera system 104 (e.g., pan and tilt), or otherwise adjusting the camera's zoom setting. This may enable the user to interactively search and scan around an animal enclosure to observe different animals, and at different levels of zoom.

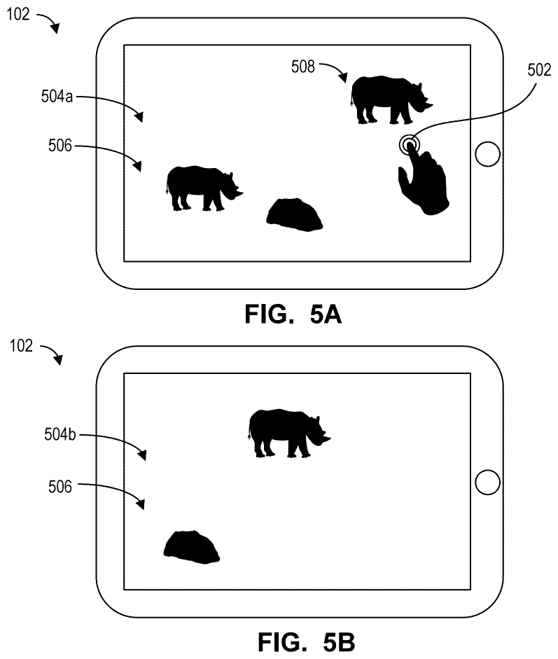

The user-generated command can also comprise a target image pixel within an image frame. For instance, as shown in FIG. 5A a user may view a media feed 504a on their display interface 506. The media feed may be generated by a selected camera system 104 located in an animal enclosure (e.g., a rhinoceros enclosure). The media feed is generated based on the current field of view of the camera system 104.

In this example, the display interface 506 comprises a touchscreen display, which can receive user inputs. As shown, the user may desire to control the camera system 104 to pan to the right, so as to generate a more focused view of rhinoceros 508. Accordingly, the user may select an image pixel coordinate 502, within the camera's field of view. The selected image pixel coordinate (x,y) may form the user-generated command. That is, the camera system 104 may be controlled to focus on the target pixel coordinate 502. In other cases, the user can also specify a zoom level (e.g., via pinching or expanding the touchscreen), which can also be included in the user-generated command. In other example cases, the user-generated command can be generated in any other manner, and using a web interface associated with the server 106.

Referring back to FIG. 3A, at 310a₁, the user device 102 may transmit the user-generated commend (e.g., image pixel and zoom selection), to server 106. In turn, the server 106 may receive the command (310a₂), and may generate a corresponding control signal for controlling the camera system 104 (312a). For example, this can involve converting the image pixel coordinates into pan and tilt controls for the camera system 104. In other cases, the control signal can also include zoom control. At 314a, the control signal is transmitted to the camera system 104.

At 316a, the camera system 104 may receive the control signal, and may execute the control signal. For example, the camera controller 108 may execute the control signal by updating the camera system's configuration settings. That is, the camera controller 108 can control a motor associated with the camera device 110 to adjust the camera's positional configuration (e.g., pan and tilt), and/or the zoom setting based on the control signal. In other examples, 312a and 314a can be performed directly on the camera controller 108.

Subsequently, method 300a may return to act 304a₁, and the camera system 104 may continue transmitting media based on its updated configuration setting. In turn, this media may be displayed back to the user device 102 (308a). This is shown, by way of example in FIG. 5B, whereby an updated image frame 504b is streamed, which is shifted relative to the image frame 504a (FIG. 5A), i.e., owing to the camera's updated position.

In other examples, it is not necessary for the viewing user to submit a user-generated command. For example, the method 300a may simply end at act 306a, with the user observing the animal in the enclosure.

To this end, it been appreciated that, in the method 300a of FIG. 3A, it is possible that a number of user devices 102 may concurrently access the same camera system 104. For example, a plurality of user devices 102 may access a single camera system 104 to stream video of the same animal enclosure. The plurality of user devices 102 may also further desire to remotely control the same camera system 104 (e.g., via user-generated commands). It may therefore be necessary to resolve conflicts between different commands received from different user devices 102.

Reference is now made to FIG. 3B, which shows an example method 300b for controlling camera configuration settings based on multiple received user-generated commands.

At 302b, the server 106 may open a voting window, which allows each user device 102 to submit a corresponding command for controlling a camera system 104. Each command can include a respective target pixel coordinate for re-focusing the camera system 104. The voting window may be open for a pre-determined time period.

At 304b, user-generated commands can be received, from one or more user devices, during the open voting window time period. At 306b, the voting window may be closed after the pre-determined period has lapsed.

At 308b, the received user-generated commands may be aggregated to generate a combined command output. For example, this may involve determining an average of each of target pixel coordinate, in each user-generated command. For instance, an x_{average} and y_{average} may be determined for each (x,y) target coordinate received. In other cases, the output can be determined as the median value of each of target pixel coordinates.

At 310b, the camera system 104 may be controlled based on the combined output command, (i.e., to focus on the output pixel coordinate). The method 300b may then return to act 302b to open the next voting window.

In at least some examples, the pre-determined time period—in which the voting window is open—may be determined based on the number of active user devices accessing a given camera system 104. For example, the voting window may be open for a greater period of time to accommodate a larger number of active user devices.

In one example case, the voting window may be open for one second if there are less than five active user devices 102. Further, the voting window may be open for 1.5 seconds if between five to ten active user devices 102 are detected. Additionally, the voting window may be open three seconds if greater than twenty five user devices 102 are detected.

In some cases, the number of active users 102 may be determined prior to act 302b. For example, in each iteration of method 300b—prior to act 302b—the system may determine the number of active connection sessions for a given camera system 104. In at least some examples, this may be determined over a predetermined time period (i.e., the number of active sessions over the last thirty seconds). Based on the number of active connections, the server 106 may determine the corresponding voting window time period.

In another example, the pre-determined time period—in which the voting window is open, may vary over time. For example, the voting window is extendable by pre-determined time increments (e.g., “x” milliseconds) whenever a new vote is received. For instance, when the server receives the first vote, it commences the voting window. If there are no other votes within an initial pre-determined time period (e.g., 0.5 seconds), then the voting window closes and the server executes on act 310b. Alternatively, if there are more votes being received by the server within the initial pre-determined period (e.g., 0.5 seconds), then then voting window is extended by the pre-defined increments. For example, the pre-defined increments can be 0.1-0.5 seconds. The voting window is extended until a given pre-defined increment has elapsed with no further votes causing further extensions. The same or different lengths of time increments can be used with each extension.

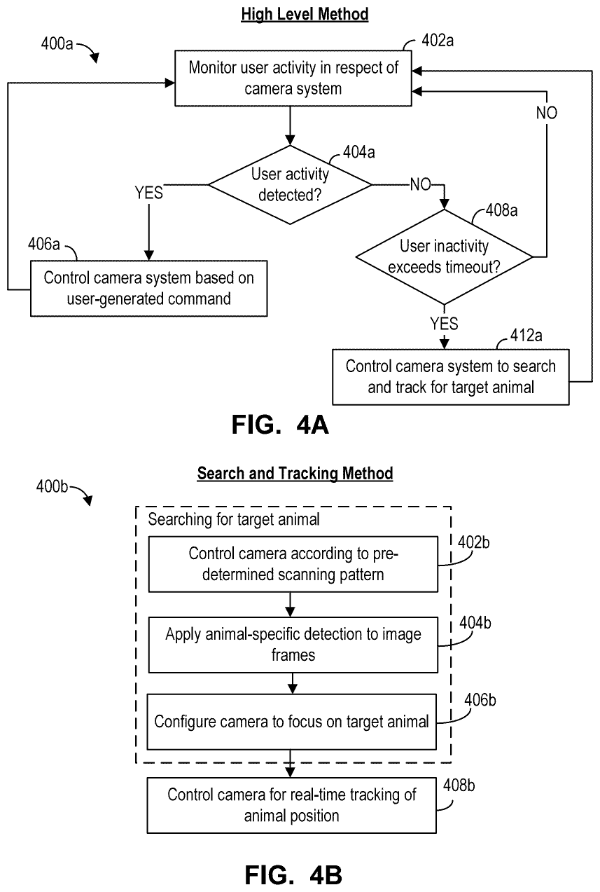

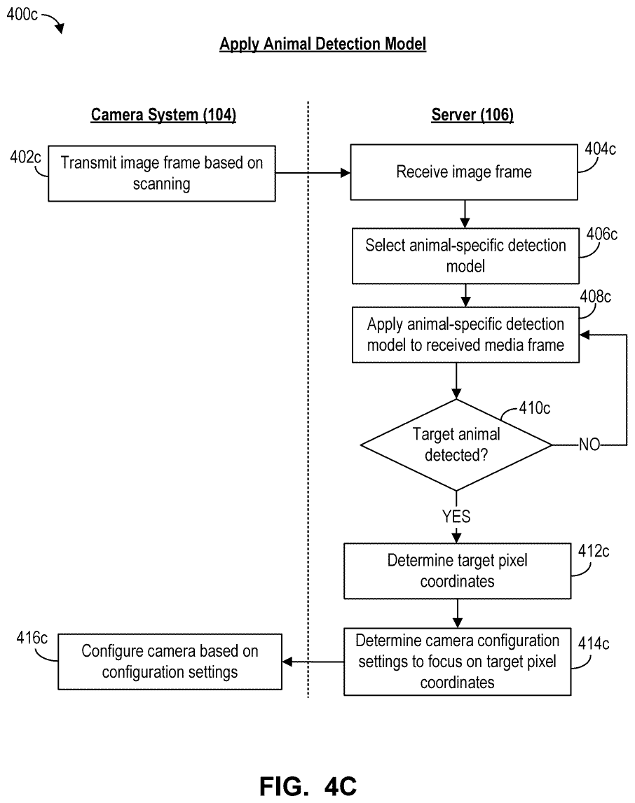

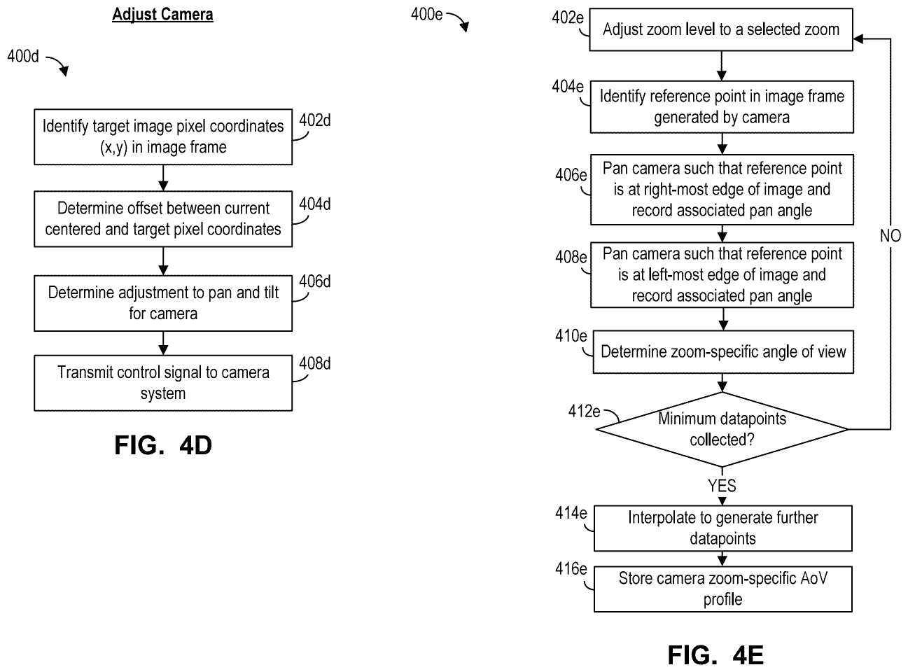

Reference is now made to FIG. 4A, which shows an example process flow for a method 400a for controlling a camera system 104 associated with an animal enclosure. Method 400a may be performed, for example, by one or more servers 106 of the systems 100a, 100b.

As shown, at 402a, the server 106 can monitor for user activity with respect to a given camera system 104. That is, the server 106 can determine whether any user-generated commands are received, in association with the camera system 104 (404a).

At 406a, if user activity is detected, then the camera system 104 is controlled by the server 106, based on the received user-generated command(s). That is, the server 106 may transmit a control signal to the system's camera controller 108 based on the received user-generated command(s) (314a in FIG. 3A, or 310b in FIG. 3B). Subsequently, the server 106 may return to act 402a to monitor for further user activity.

Otherwise, at 408a, if no user activity is detected—the server 106 may determine whether a user inactivity time has exceeded a pre-determined timeout period (e.g., 10 minutes).

In at least some cases, at act 408a, the server 106 may monitor the user inactivity time by monitoring the last control signal transmitted to the camera system 104. The server 106 may then determine if the last control signal was transmitted within the pre-determined timeout period. If not, the server 106 may determine, at act 408a, that the camera system 104 is inactive.

In other cases, the camera system 104 may, itself, inform the server 106 if the user inactivity time exceeds the timeout period. For example, the camera system 104 may monitor the last received control signal to determine its idle time. The camera system 104 may then transmit an inactivity signal to the server 106 if the camera's idle time exceeds the pre-determined inactivity time out period (e.g., 10 minutes). Accordingly, at act 408a, the determination is positive once the inactivity signal is received from the camera system 104. Otherwise, if no inactivity signal is received, the determination at act 408a is negative.

If the determination at act 408a is negative, then the server 106 may return to act 402a to continue monitoring for user activity. Otherwise, if the determination at act 408a is positive, then the server 106 may proceed to act 412a.

At act 412a, the server 106 can determine that no users are accessing and/or controlling the camera system 104, and therefore the camera system 104 is idle. In these cases, the server 106 may invoke a search and track routine, which enables controlling the camera system 104 to search and track for one or more target animals within the animal enclosure associated with the camera system 104.

More particularly, act 412a ensures that the camera system 104 is tracking an animal such that the next user device 102, to access the camera system 104, is able to automatically view a tracked animal inside the enclosure. In turn, this avoids cases where the camera system 104 is directed to an uneventful area within the animal enclosure when users begin re-accessing the camera system 104.

Reference is now made to FIG. 4B, which shows a process flow for an example method 400b for controlling a camera system 104 to search and track for a target animal, within an animal enclosure (i.e., act 412a in FIG. 4A).

Method 400b broadly includes two portions, (i) initially, searching for the target animal within the animal enclosure, using the camera system 104 (acts 402b-406b), and (ii) subsequently, tracking the target animal using the camera system 104 in real-time or near real-time (act 408b).

In method 400b, the target animal, which may be searched and tracked, may be simply any animal located within the animal enclosure. In other cases, if more than one animal type is located in an animal enclosure, the target animal may correspond to one or more specific animal types of the plurality of animal types.

In at least some cases, server 106 may allocate (i.e., assign) different camera systems 104 to search and track different animals. For example, this may be based on the animal enclosure associated with that camera system 104. For example, a camera system 104 associated with a rhinoceros enclosure may be assigned to search and track only rhinoceroses. Where there are a number of animal types in the same enclosure, each camera system 104 associated with that enclosure may be assigned to search and track the same or different animal types.

In more detail, at 402b, the server 106 may initially control the camera system 104 to search for one or more respective target animal(s) within the associated animal enclosure. This may be performed by the server 106 controlling the camera system 104 to follow a pre-determined scanning pattern.

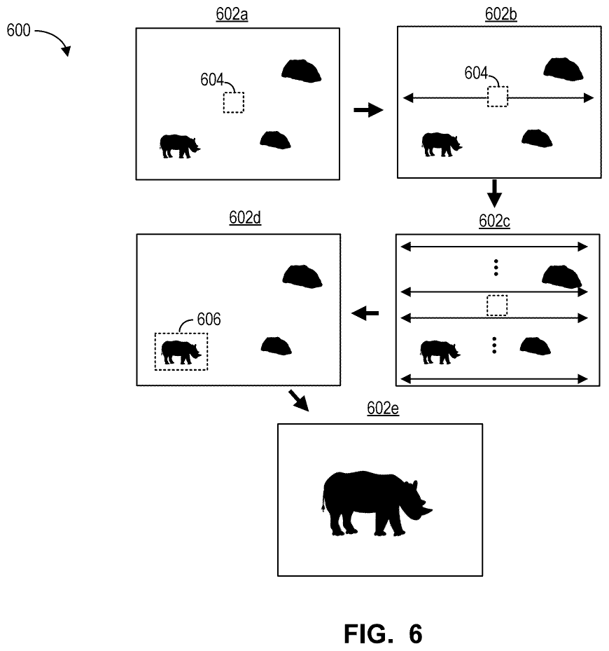

To this end, reference is briefly made to FIG. 6, which shows pictorial illustrations of an example scanning technique applied at act 402b, in FIG. 4B.

At 602a, the camera controller 108 may initially control the camera 110 to adopt a default configuration setting. The default setting may involve adjusting the camera to a pre-defined camera position (i.e., default pan and tilt). It may also involve adjusting the camera zoom view to a default zoom level. The camera's field of view, in the default configuration, is shown by way of example as box 604 in 602a. In this example, the camera's field of view is relatively centered within the enclosure environment.

From the default position, the camera controller 108 may proceed to control the camera to scan different portions of the environment. This may involve: (i) initially, panning the camera from left to right along a constant tilt, (ii) subsequently, adjusting the tilt, and (iii) iterating by panning the camera from left to right along the adjusted tilt, and so forth.

For example, at 602b, camera controller 108 may initially control camera 110 to pan horizontally to a right-most limit and then to a left most limit. This may be performed with no adjustments to the default tilt. In this manner, the camera scans an initial “row” in the enclosure environment (also referred to as the default row). If the target animal is not located, at 602c, the camera controller 108 may then adjust the camera tilt to scan a first “row” above and below the default row. The camera controller 108 may then continue to adjust the camera's tilt to iteratively scan the subsequent rows above and below the default row.

Returning to FIG. 4B, as the camera is adjusting its field of view throughout the scan process, it may transmit image frames back to the server 106. The image frames may be received continuously, or at pre-defined time or frequency intervals. In other cases, only non-overlapping image frames, generated by the camera system 104, are transmitted back to the server 106. The server 106 may receive the image frames, and at act 404b, and may then apply an animal-specific detection program to detect the target animal within each received image frame.

In some example cases, as provided herein, the animal-specific detection program may be a trained machine learning model, which is trained to detect specific target animals. The server 106 may execute different animal-specific detection models based on the camera system 104 performing the scan. For example, for a camera system 104 associated with a hippopotamus enclosure, the server 106 may apply a hippopotamus-specific detection model to identify hippopotamuses in image frames generated by the scanning camera.

In other examples, animals can be detected in image frames using computer vision techniques (e.g., object detection algorithms). For example, these can include techniques that identify a degree of similarity between an imaged object and a target object. For instance, this can involve identifying a hippopotamus in an image frame by comparing the captured image with a known image of a hippopotamus. Examples of computer vision techniques include, by way of non-limiting examples: (i) Feature Detection And Matching; (ii) Harris Corner Detector; (iii) SIFT (Scale-Invariant Feature Transform); (iv) SURF (Speeded-Up Robust Features); (v) FAST (Features from Accelerated Segment Test); (vi) BRIEF (Binary Robust Independent Elementary Features); and/or (viii) ORB (Oriented FAST and Rotated BRIEF) techniques.

At 406b, once the target animal is detected, the server 106 may interrupt the scanning process and configure the camera system 104 to focus on the target animal. For example, as shown in FIG. 6, the target animal 606 may be detected (602d), and the camera system 104 is controlled to focus and/or zoom-in on the target animal (602e).

If the target animal is not detected after an initial complete scan is complete—the camera system 104 may be controlled to perform another iteration of the scan (i.e., re-scanning each row of the environment in turn). To this end, the camera controller 108 may wait a pre-determined wait out time period (e.g., a few seconds or minutes) between each consecutive scan. This may allow sufficient time for animals to relocate their position inside the animal enclosure. For example, animals may be momentarily hidden behind various obstacles in the enclosure (e.g., trees, bushes or large rocks), and accordingly, may not be detected in the initial scan. As such, the wait out period provides enough buffer time for the animals to move to a new position in the enclosure such that the animals are detectable by the camera system 104.

In some example cases, the wait out time period between scans may progressively increase as a greater number of scanning iterations are performed. For example, the camera system 104 may only wait a few seconds between a second and third scan, but may wait for a number of minutes between the eight and tenth scan, and so forth.

In still other example cases, the wait-out period can also be based on the number of frames. For example, detecting animals every 15 frames such that if the camera is streaming 30 fps (Frame Per Second), then the detection would run at 0.5 second intervals.

At 408b, once the camera system 104 is configured to focus on the target animal, the camera system 104 may be further controlled for real-time or near real-time tracking of the target animal.

Referring now to FIG. 4C, which illustrates an example method 400c for configuring the camera system 104 to focus on a target animal (i.e., act 406b in FIG. 4B).

At 402c, the camera controller 108 may transmit a media feed to the server 106. The media feed can be a real-time or near real-time video feed (i.e., a live video stream), at any desired frame per second (fps). In some cases, the media feed can also be discrete image frames transmitted at pre-defined time or frequency intervals.

At 404c, the server 106 may receive the media frames, e.g., in the media feed. At 406c, the server 106 may select an animal-specific detection model to apply to the image frames.

In some example cases, the server 106 may select the correct animal-specific detection model, at 406c, based on the camera system 104 transmitting the media feed. For instance, as previously noted, different camera systems 104 may be assigned to monitor different target animals. For instance, this can be based on the animal enclosure associated with that camera system 104. Accordingly, an animal-specific model can be a machine learning model that is specifically trained to identify and/or label specific target animals in received image frames. In some examples, animal-specific models can also vary as between species within the same animal type. These can be called species-specific models, but for ease of reference, are also referred to herein as animal-specific models. There may also be models which are trained to detect a specific singular animal within the enclosure (e.g., a specific singular penguin, etc.)—for ease of reference, these also referred to herein as animal-specific models.

In some cases, server 106 may store a database of different camera systems 104, and target animals assigned to each camera system 104 to monitor. For instance, each camera system 104 may be identifiable by a unique camera ID. Accordingly, the server database can store a table of camera IDs and associated target animals monitored by that camera ID. In these cases, when a media feed is received from that camera system 104, the server 106 may instantiate (or invoke) the relevant animal-detection model(s) associated with that camera system 104, with reference to the database.

In other cases, the stored database can simply associate camera systems 104 (e.g., referenced by camera IDs) with one or more associated animal-specific detection models. Accordingly, when a media feed is received from the camera system 104, the system can instantiate and apply the corresponding animal-specific detection model.

In some examples, multiple animal-specific detection models can be associated with the same camera system 104. Further, the appropriate animal-specific model to apply can vary based on one or more model selection factors.

For instance, a model selection factor can be the time of day. For example, each camera system 104 may monitor different animals, at different times of day. That is, each camera system 104 can have a corresponding monitoring schedule indicating which animal(s) to monitor at which times of day. Upon receiving image frames—server 106 can determine the current time of day (e.g., based on an internal clock), and apply the appropriate animal detection model(s) with reference to the monitoring schedule.

In some examples, server 106 can store, in association with each camera system 104—one or more animal-specific detection models, and a corresponding time instance or time range for applying that animal-specific detection model. Accordingly, a model application schedule can be stored, which correlates different models to apply at different times of day.

Model selection factors can also depend on inputs received at the server 106 and/or controller 108. For example, an input can be received from an operator designating that an animal-specific model be applied now or in the future. An input can also correspond to a sensor input—for example if a light sensor can detect nighttime versus daytime, and different animal-specific detection models can be designated for a camera system 104 to detect certain animals in daytime versus nighttime.

In some examples, the server 106 can store a database of different camera devices 110, and target animals (or animal-specific detection models) assigned to each camera device 110. This being more specific example than storing models in association with each camera system 104, as a whole. This may be useful if each camera system 104 includes a camera controller 108 coupled to multiple camera devices 110, Accordingly, it may be necessary to specify, at a greater level of detail, which camera device 110 is associated with which models. Each camera device 110 is again identifiable by a different camera ID.

While method 400c is so far described as being performed by server 106, in other examples, method 400c is also performable directly on a camera controller 108. For example, camera controller 108 can store one or more animal-detection models. In some examples, the camera controller 108 is connected to multiple camera devices 110, and can store animal-specific detection models in association with each camera device 110. The camera controller 108 can determine which model to apply, for image frames received from a camera device 110, having regard to the one or more model selection factors.

At 408c, the selected animal-detection model may be applied to the received image frame to determine whether the target animal is identifiable within the image frame.

At 410c, a determination is made whether the target animal is identified in the received image frame. If not, the method can return to act 404c to receive the next image frame from the camera system 104, and may iterate acts 406c-410c. Here, it will be understood that act 406c (i.e., selecting the appropriate animal-specific detection model) need not be performed with each iteration of acts 404c-410c, and may only be performed once. In other cases, the act 406c may also be performed prior to act 404c.

Otherwise, at act 412c, if the target animal is detected within a given image frame, the server 106 may determine the pixel coordinates for the detected animal within the image frame. For example, this can correspond to central pixel coordinates for the detected animal.

At 414c, the server 106 may determine the camera configuration settings required to focus the camera system 104 on the target pixel coordinates. For example, this can involve determining the camera position settings (e.g., pan and tilt) to center the camera's field of view on the target pixel coordinates. As well, this can also involve determining the camera zoom settings to allow the animal to “fill-up” the camera's field of view. In some example cases, the camera zoom settings are controlled such that the longer edge, of the detected animal's width and height, occupies a ratio of 0.3 to 0.55 the field of view of the corresponding edge of the camera's image frame. The server 106 may then transmit these camera configuration settings to the camera system 104 via a control signal (e.g., analogous to act 314a in FIG. 3A).

At 416c, the camera system's camera controller 108 can interrupt the scanning process and can receive the control signal, and in turn, may adjust the camera to execute the desired configuration settings. In some examples, all of acts 406c-414c can be performed on a camera controller 108, in addition to—or in the alternative of—being performed on server 106.

Referring now to FIG. 4D, which shows an example method 400d for controlling the camera position settings to focus on target pixel coordinates. Method 400d may be performed, for example, by the server 106 during act 406b in method 400b (FIG. 4A) and/or act 414c in method 400c (FIG. 4C).

As shown, at 402d, target pixel coordinates can be identified in an image frame generated within the camera's current field of view (FoV). The pixel coordinates may be expressed in terms of cartesian coordinates (e.g., x, y pixel coordinate values), and with reference to a pre-defined origin point within the image frame.

In some example cases, the target pixel coordinates are received as a user input from a user device 102 (i.e., the user-generated command). For instance, as shown in FIG. 5A, the user may select a pixel coordinate 502—in the image frame 504a—corresponding to an area within the camera's FoV that the user desires to focus on. In other example cases, the target pixel coordinates may be generated by the server 106 (412c in FIG. 4C). For example, as shown in FIG. 4C, an animal-specific detection model may identify a target animal at a given pixel coordinate location within an image frame.

At 404d, an offset between a current centered pixel coordinate, and the target pixel coordinate, is determined.

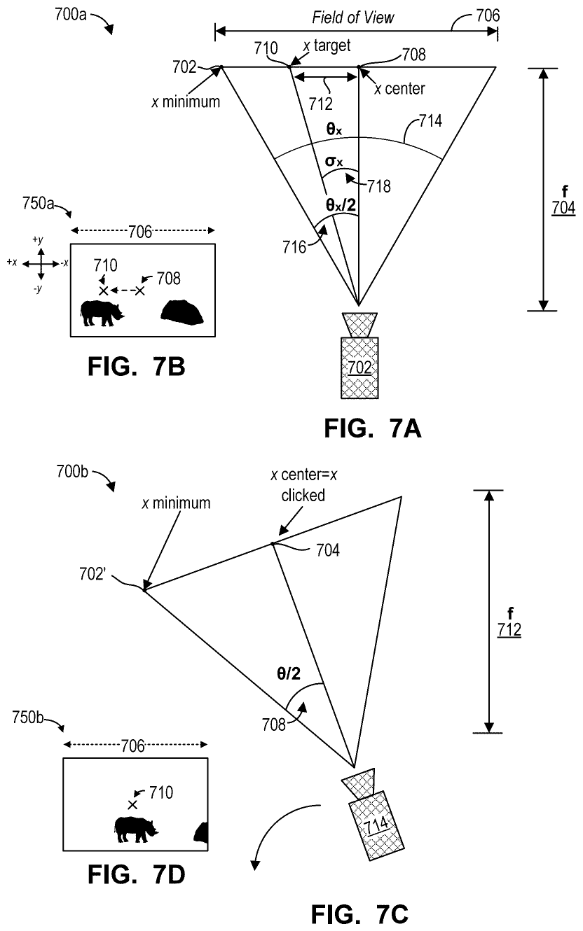

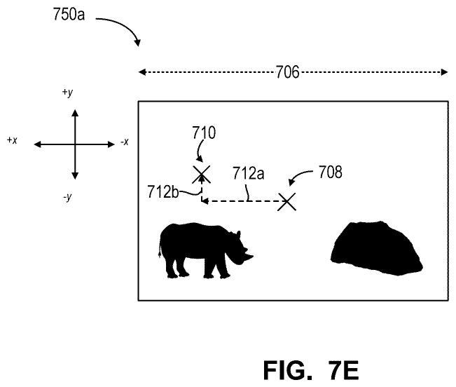

By way of illustrative example, FIG. 7A shows an initial position state 700a for a camera 702. The initial position state is illustrated along an x-axis, defined with respect to the environment surrounding the camera. As shown, camera 702 is adjusted to a zoom level characterized by a focal length (f) 704, and an x-axis field of view (FoV) 706.

FIG. 7B shows an example image frame 750a generated by the camera in the initial position state 700a. As shown, in the initial position state, pixel 708 is centered within the camera's x-axis field of view 706. Pixel 708 therefore corresponds to the current centered pixel coordinate.

As further shown, the pixel coordinate 710 represents the target pixel x-coordinate. That is, it is desired to re-orient the camera 702 (i.e., pan the camera) such that the target pixel coordinate 710 is centered within the camera's x-axis FoV.

For sake of simplicity, it is assumed in FIG. 7A that there is no change in camera's current and target y-axis. That is, it is not required to tilt the camera along the y-axis to re-focus on the target image pixel. Rather, it is simply desired to pan the camera, across the x-axis, to re-focus on a new x-axis coordinate 710 (see e.g., FIG. 7B).

Accordingly, at 404d, an offset is determined between the current centered pixel coordinate 708 and target image pixel coordinate 710 (i.e., calculated as the difference between the two coordinate points 708, 710). In FIG. 7A, this is exemplified as offset 712 along the x-axis.

To this end, FIG. 7E shows an example where the target pixel coordinate 710 is shifted along both the x- and y-axis, relative to the current centered image pixel coordinate 708. In this case, at 404d, two offset parameters are determined: (i) an x-axis offset 712a, and (ii) a y-axis offset 712b.

Continuing reference to FIG. 4D, at 406d, an adjustment to the camera position settings is determined to center the target pixel coordinates 710 within the camera's field of view (FoV). That is, an adjustment to the camera system's pan and tilt is determined to compensate for the offset 712. Here, it is assumed that adjusting the camera's pan corresponds to moving of camera along the x-axis, and adjusting the camera's tilt corresponds to moving the camera along the y-axis.

FIG. 7A shows an example technique for determining the pan movement angle to focus the camera 702 on a target x-coordinate 710. It will be understood that an identical technique can be applied to determine the tilt angle for focusing the camera on a target y-coordinate. That is, in FIG. 7E, the technique described in FIG. 7A can be applied separately to determine the pan angle to compensate for the x-axis offset 712a, and again to determine the tilt angle to compensate for the y-axis offset 712b.

In the example of FIG. 7A, ex expresses the camera's x-axis angle of view (AoV) 714 at the camera's current zoom level. Accordingly, the camera must be panned by an angle of (θx/2) 716 in order to entirely modify the camera's existing field of view, along the x-axis, to a new field of view (also known as the full pan angle 716).

In view of the foregoing, to center the target x-axis pixel coordinate 710—camera 702 may be panned by a pan movement angle (σₓ) 718. Pan angle (σₓ) 718 expresses a proportion of the full pan angle (θx/2) 716. Determining the pan movement angle (σₓ) 718 is based mathematically on Equation (1):

$${σ}_{x} = arctan arctan ( \vert tan \frac{{θ}_{x}}{2} \vert \times \frac{{x}_{target} - {x}_{center}}{\vert {x}_{target} - {x}_{min} \vert} ) \qquad ( 1 )$$

wherein xₘᵢₙ defines the minimum edge frame x-coordinate 702 in the camera's current field of view 706.

In cases where there the target pixel coordinate includes a y-axis offset (FIG. 7E), then a similar process is applied to determine the tilt movement angle (σ_{y}) to center the target y-axis pixel coordinate, i.e., in accordance with Equation (2):

$${σ}_{y} = arctan arctan ( \vert tan \frac{{θ}_{y}}{2} \vert \times \frac{{y}_{target} - {y}_{center}}{\vert {y}_{target} - {y}_{min} \vert} ) \qquad ( 2 )$$

wherein the camera's y-axis angle of view (θ_{y}) is again defined with respect to the camera's current zoom level. In some cases, the y-axis angle of view (θ_{y}) may be identical, or different, to the camera's x-axis angle of view (θₓ).

Accordingly, in FIG. 7E, centering the target pixel 712 requires panning the camera by pan movement angle (σₓ), and tilting the camera by tilt movement angle (a_{y}).

Referring back to FIG. 4D, at 408d, the server 106 may transmit a control signal to the camera system 104, which includes one or more of the pan and tilt movement angles (σₓ, σ_{y}) required to center the target pixel in the camera's field of view. The camera system's controller 108 may receive the control signal, and proceed to control the camera position to execute the required movement angles.

As noted in Equations (1) and (2), the pan and tilt movement angles (σₓ, σ_{y}) are based on pre-determined knowledge of the camera's angle of view (AoV) (θₓ, θ_{y}), at a given zoom level. In some example cases, an initialization process is used to establish the camera's angle of view (θₓ, θ_{y}) at different zoom levels. This initialization process facilitates the determination of the pan and tilt movement angles (σₓ, σ_{y}) in Equations (1) and (2). The initialization process may be performed, for example, prior to deploying and using a camera system 104.

Reference is now made to FIG. 4E, which shows an example method 400e for an initialization process used for establishing a camera's angle of view (AoV) profile. The camera's angle of view (AoV) profile includes the camera's x- and y-axis angle of view (θₓ, θ_{y}) at different zoom levels. In cases, where the camera may have different x- and y-axis angle of view (AoV) profiles, the camera's AoV profile may be determined independently for each of the x- and y-axis (i.e., method 400e may be repeated separately to determine the x- and y-AoV profiles).

As shown, at 402e, for a given camera system 104, the camera's zoom may be adjusted to a selected zoom level (e.g., 25% zoom).

At 404e, a reference point is identified in the image frame generated by the camera at that zoom level. The reference point can be any point within the camera's current field of view. For instance, in some examples, the reference point may correspond to an image pixel in the displayed camera image frame. In other cases, the reference point may correspond to a physical object displayed in the camera's image frame.

In some cases, the reference point may be manually selected by a camera operator. For example, an operator may use an operating computer connected to the camera system 104. The computer can be used to control the camera system 104, and may further include a display for displaying image frames generated by the camera system 110. Accordingly, the operator—observing the displayed image frame—may select a reference point in the camera's current field of view. In other cases, the reference point may be automatically identified by the server 106, receiving the image frame. For instance, the server 106 may use any known image analysis method to analyze the received image frame and select a reference point in that image frame.

At 406e, the camera is controlled such that the camera is panned to position the reference point at the right-most edge of the camera's field of view. That is, the reference point should be positioned at the right-most edge of an image frame output by the camera. This may be performed manually be a camera operator, or otherwise automatically (i.e., by server 106). The camera's pan angle, in this position state, is recorded, i.e., as pan angle ‘A’.

At 408e, the camera 110 is panned such that reference point is now positioned at the left-most edge of the camera's field of view. The camera's pan angle, in this position state, is recorded, i.e., as pan angle ‘B’.

At 410e, the camera's zoom-specific AoV is determined by subtracting pan angle ‘A’ from pan angle ‘B’ (or vice-versa). This value corresponds to the camera's angle of view (AoV) at the zoom level selected at 402e.

It will be understood that, in other cases, acts 406e and 408e may be reversed such that act 408e occurs prior to act 406e.

At 412e, it is determined whether a minimum number of datapoints are collected. As used herein, a single datapoint corresponds to a single determined zoom-specific AoV (410e), at a given zoom level.

In at least some example cases, for each camera system 104, a minimum of three datapoints are required at three different zoom levels. For example, the zoom-specific angle of view (AoV) may be determined at 0% zoom level, 33% zoom level and 100% zoom. This is to enable more accurate interpolation of further datapoints at act 414e, as explained herein. The minimum number of datapoints may be determined in advance, e.g., by a system operator. For example, a system operator may specify the required zoom levels for which datapoints must be collected.

If the minimum number of datapoints are not collected, the method 400e may return to act 402a, and may iterate to determine the next zoom-specific AoV for the next zoom level.

Otherwise, at 414e, an interpolation technique may be used to determine further datapoints. For example, if acts 402e-410e determine zoom-specific AoVs at three zoom levels (e.g., 0%, 33% and 100%), interpolation is used to determine the zoom-specific AoV for the remaining zoom levels, e.g., as between 0% and 100%. In this manner, the system may generate a continuous function that relates AoVs to camera zoom levels.

In at least one example, at act 414e, an interpolation method is used based on Equation (3):

$${θ}_{target} = ( \frac{1}{\frac{1}{tan tan \frac{{θ}_{1}}{2}} + ( {Z}_{target} - {Z}_{1} ) \frac{\frac{1}{tan tan \frac{{θ}_{2}}{2}} - \frac{1}{tan tan \frac{{θ}_{1}}{2}}}{{Z}_{2} - {Z}_{1}}} ) \qquad ( 3 )$$

wherein θ₁ is the zoom-specific AoV at a first zoom level (Z₁), θ₂ is the zoom-specific AoV at a first zoom level (Z₂), and θ_{target} is the desired interpolated zoom-specific AoV for a given target zoom level (Z_{target}).

By way of example, if it is desired to determine the AoV at 25% zoom level, and the AoVs were previously acquired at 0% and 33% zoom levels (act 410e)—θ₁, θ₂ may correspond to the determined AoVs for zoom levels 0% and 33%, respectively.

Equation (3) is derived from a combination of Equation (4) (i.e., expressing the pinhole camera model), Equation (5) (i.e., expressing the general behavior of camera zoom as a function of focal length (f)) and Equation (6) (i.e., expressing the linear interpolation of a target zoom).

$$2 \times arctan \frac{r}{f} \qquad ( 4 )$$

$$\frac{{Z}_{x / y}}{{Z}_{x / y 1}} = \frac{f}{{f}_{1}} \qquad ( 5 )$$

$${Z}_{x / y} = {Z}_{x / y 1} + ( {Z}_{o n} - {Z}_{o n 1} ) \frac{{Z}_{x / y 2} - {Z}_{x / y 1}}{{Z}_{o n 2} - {Z}_{o n 1}} \qquad ( 6 )$$

It will now be understood that selecting three datapoints, as the minimum number of datapoints at 412e, allows for more accurate interpolation between these datapoints. However, in other cases, the minimum number of datapoints may vary. For example, different camera models (e.g., with higher zoom capabilities) may require different numbers of initial datapoints for effective and accurate interpolation.

In other example cases, rather than using Equation (3), the interpolation can be based on a simple linear interpolation technique as between previously acquired AoVs, or otherwise, any other interpolation technique.

At 416e, the camera's zoom-specific AoV profile may be stored, e.g., on server 106 and/or camera controller 108. In this manner, when it desired to determine the adjustment to the camera's pan and tilt (406d in FIG. 4D), the camera's pre-determined AoV profile, at a given zoom level, may be retrieved from memory and referenced for Equations (1) or (2).

In some example cases, method 400e may be performed twice to determine a cameras x-axis and y-axis AoV profiles. The x-axis AoV (θₓ) profile is then used in relation to Equation (1), whereas the y-axis AoV (θ_{y}) profile is used in relation to Equation (2).

In still some other example cases, the interpolation at act 414e may not be performed ahead of time, but may be performed “on the go” during act 406d in FIG. 4D. For example, at act 406d in FIG. 4D—the system may, (i) initially, determine the camera's current zoom level, and (ii) based on the existing pre-stored datapoints determined at act 412e, further determine the camera's AoV for the current zoom level based on performing the interpolation. The interpolated AoV is then used, at act 406d, in Equations (1) and/or (2) to determine the pan and tilt movement angles. In some cases, once the AoV is determined, it may also be stored in memory for subsequent use. In this manner, the camera's AoV profile may be built-up over time.

In other example cases, in method 400e—rather than interpolating at act 414e, the camera AoV profile may be generated by simply iterating through acts 402e-412e for all possible zoom levels.

In still yet other example cases, method 400e may not be entirely necessary. For example, the camera's AoV profile may be known ahead of time, with reference to a camera specification sheet. Accordingly, the specification sheet data may be simply uploaded to the server memory for future reference.

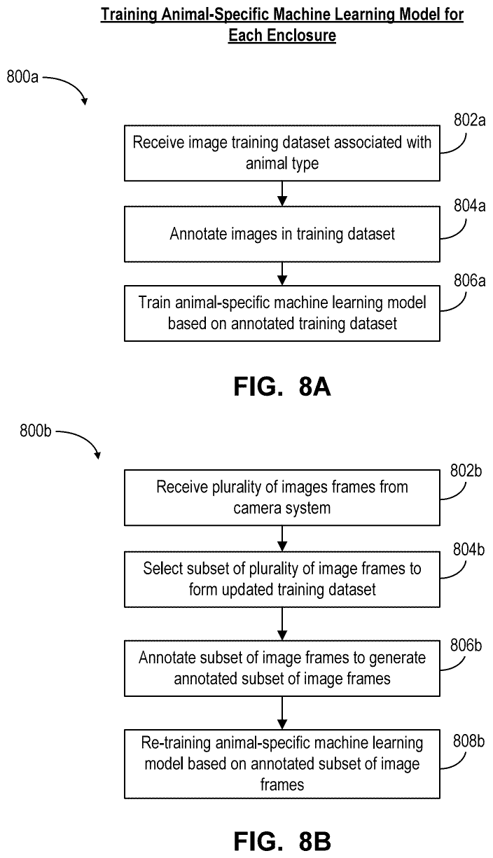

Reference is now made to FIG. 8A, which illustrates an example method 800a for training an animal-specific machine learning detection model. The trained model can be applied at act 404b, in FIG. 4B. Method 800a may be performed, for example, on server 106.

At 802a, a training set of image frames are received. The image training set may include an array of images captured of a target animal. For example, this can include images captured of the animal at different camera zoom levels (e.g., 0%, 33%, 100%, etc.), and images captured of the animal in different poses (e.g., front, back, rear, etc.).

The array of training images can also include images captured of the animal in different settings. For example, as shown in the hippopotamus enclosure 200b of FIG. 2—this may include images of an animal 202b₁ partially submerged in water 208b, and/or image of the animals 202b₂ standing on land/ground 206b. In other cases, it can include images of the animal partially obscured by various obstacles (e.g., rocks, trees, etc.). In this manner, the model may be trained to identify the animal in different settings. The training dataset can also include images of the target animal captured in different environmental conditions (e.g., raining, sunny, cloudy, night/day, etc.), images of the target animal captured at different times of day as well as images captured in different dim light levels. With respect to images of the target animal captured at night, this may accommodate a feature where the camera operates in an infrared (IR) mode when the camera does not detect sufficient light. Accordingly, the training images can include black and white frames when the camera is in an IR mode.

Still further, the training set can include images of different sizes of the target animal. For example, as again shown in the hippopotamus enclosure 200b of FIG. 2—this can include images of smaller hippopotamuses 202b3 and larger hippopotamuses 202b2. Accordingly, this may account for younger and older animals.

In some example cases, the training dataset may include images of the target animal whereby the images have varying image resolutions or sizes (e.g., 416, 800, 1088, 1920 image resolution), as well as varying image orientations (e.g., flipped, reshaped, rotated, etc.).

Accordingly, it will be appreciated that the training image dataset can include a large diversity of image types to generate a well-trained machine learning model.

At 804a, the training images can be annotated with the location of the target animal in each image. For example, a bounding box may be generated around the location of the target animal, in each training image. In some example cases, this may be performed by a system operator (or 3^{rd} party), and using a dedicated computer which is connected to server 106.

At 806a, the annotated training dataset may be fed into an untrained animal-specific machine learning model, and used to generate a trained animal-specific machine learning model.

In at least one example case, the trained machine learning models uses the open source YOLO (You Only Look Once) objection detection algorithm architecture. In some cases, a version 5 YOLO architecture (“Yolov5”) is used for the machine learning model (e.g., a YOLOv5m, or YOLOv5s).

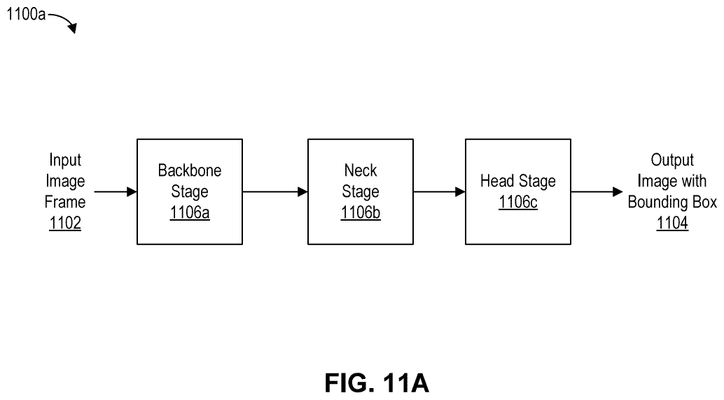

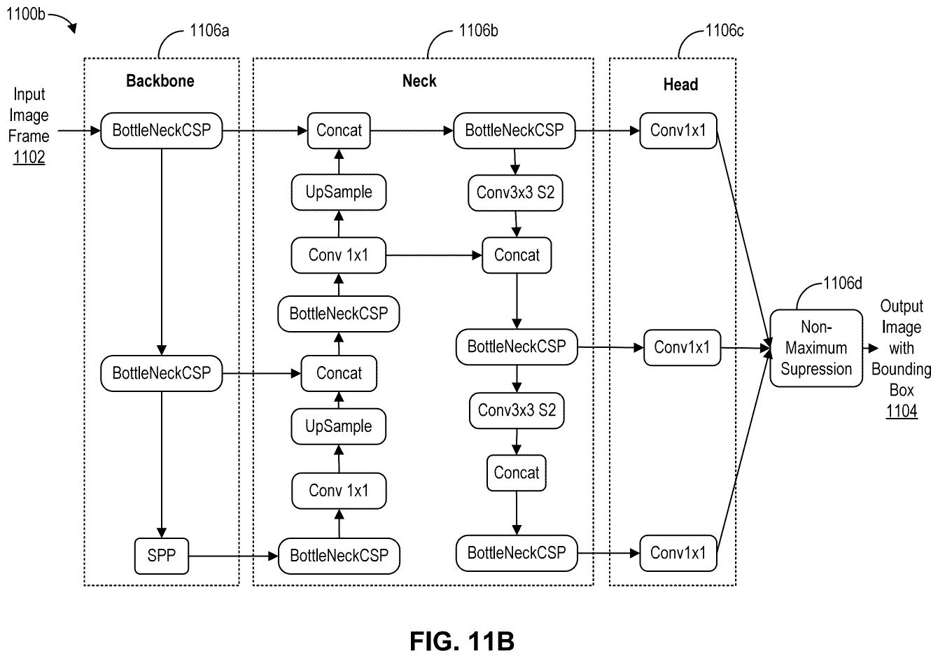

FIG. 11A shows an example general Yolo network architecture 1100a, which can be used, as is known in the art. FIG. 11B shows an example Yolov5 network architecture 1100b, as is also known in the art, and which can be trained in accordance with the teachings herein.

As shown, the Yolo network architecture generally includes a backbone stage 1106a, a neck stage 1106b, a head stage 1106c, and can also include a non-maximum suppression stage 1106d (FIG. 11B).

The backbone stage 1106a comprises a convolutional neural network that aggregates and forms image features at different granularities. In some examples, the backbone stage 1006a uses a CSP backbone. “CSP” refers to a cross stage partial network. Any type of CSP backbone can be used, including CSPDarknet53. CSPDarknet 53 uses a CSPNet strategy to partition the feature map of the base layer into two parts and then merges them through a cross-stage hierarchy. The use of a split and merge strategy allows for more gradient flow through the network.

The neck stage 1106b is a series of layers to mix and combine image features to pass them forward to prediction. In some examples, the neck stage 1106b is used to generate feature pyramids, which assists the model to generalize well on object scaling. The neck stage 1106b helps to identify the same object with different sizes and scales. The neck stage 1006b can be based on a PANet (Path Aggregation Network) architecture.

The head stage 1106c consumes features from the neck and takes box and class prediction steps. The non-maximum suppression 1106d is then used select one entity (e.g., bounding boxes) out of many overlapping entities (e.g., based on a confidence level).

When trained, the backbone stage 1106a receives an input image frame 1102. This input image frame 1102 is processed through the stages, and an output image 1104 is generated which generates a bounding box around the target animal. A plurality of Yolov5 architectures can be trained to generate a corresponding plurality of animal-specific detection models. Each network is a separately trained architecture configured to generate a bounding box around the specific target animal that the model is trained to identify in the input image frame.

FIG. 11B shows an example Yolov5 architecture used in an animal-specific detection model. “SPP” refers to a spatial pyramid pooling, “conv” refers to a convolution layer using the indicated pixel×pixel convolution block size, “Concat” refers to a concatenation function. Various up-sampling layers are also included. The input data (i.e., input image) is passed through the various layers and functions as indicated by the arrows.

In one example, the training of the Yolo architecture is conducted using a transfer learning method. Pre-trained weights were trained used to initiate the neurons (e.g., using Ultranalytic®). Training image resolution was shrunk to 800×576 pixels for training. Approximately 100 episodes of training are conducted using a batch size of “45” on a Nvidia® K80 GPU. Approximately 70% of the labeled training images are used as training set, 20% are used as validation set, and 10% are used as testing set. In a case where a model demonstrated false positives (e.g., detecting false targets), the model is re-trained with additional training images (e.g., 10-30 training images) of the target object at different zoom levels until it achieved 100% accuracy.

Reference is now made to FIG. 8B, which illustrates an example method 800b for updating an animal-specific machine learning detection model. Method 800b may be performed, for example, on server 106.

At 802b, the system may receive a plurality of image frames from at least one camera system 104 monitoring the target animal. The plurality of image frames may be collected over a pre-determined time period (e.g., ten to twenty days). In some cases, a video stream may be received, in which case the video stream may be converted into the plurality of image frames.

At 804b, a subset of the plurality of image frames are selected to form the updated training dataset. For example, this may involve selecting only informative image frames, and removing uninformative image frames (e.g., image frames that do not include the target animal).

At 806b, an annotated subset of image frames is generated, in which the target animal is identified (e.g., via bounded box) in each image frame.

At 808b, the animal-specific machine learning detection model is re-trained using the annotated subset of image frames. In this manner, the accuracy of the machine learning model may be maintained.

In at least some example cases, the machine learning detection model may not only be animal-specific, but may also be enclosure-specific. That is, the training dataset in methods 800a and 800b may be specifically generated by one or more camera systems 104 installed in the enclosure where the target animal is located. In turn, the trained model may only be deployed in association with these camera systems. This can allow for an “over-fitted model”, which is specifically adapted to accurately identify a target animal located within a specific enclosure.

Still further, the animal-specific model can also be camera-specific. That is, the training dataset in methods 800a and 800b may be specifically generated for each unique camera system 104, based on images previously captured by that camera system 104 of the target animal. Accordingly, at 404b in FIG. 4B, the applied animal-specific detection model may be specific to each unique camera system 104. This may further enhance the accuracy of the detection model to account for the installation position of each individual camera system in an enclosure, and to further accommodate for any unique features or irregularities of different camera systems.

Reference is now made to FIG. 9A, which shows a simplified block diagram of an example user device 102.

As shown, the user device 102 may include a processor 902a which is coupled, via a data bus, to one or more of a memory 904a, a communication interface 906a, a display interface 908a and an input interface 910a.

Processor 902a can be a computer processor, such as a general purpose microprocessor. Alternatively, processor 202a may be a field programmable gate array, application specific integrated circuit, microcontroller, or other suitable computer processor. While referenced in the singular, processor 902a may in-fact comprise one or more processors.

Processor 902a can be coupled, via a computer data bus, to memory 904a. Memory 904a may include both volatile and non-volatile memory. Non-volatile memory stores computer programs consisting of computer-executable instructions, which may be loaded into volatile memory for execution by processor 904a as needed. It will be understood by those of skill in the art that references herein to the user device 102 as carrying out a function or acting in a particular way imply that processor 904a is executing instructions (e.g., a software program) stored in memory 904a and possibly transmitting or receiving inputs and outputs via one or more interface. Memory 904a may also store data input to, or output from, processor 902a in the course of executing the computer-executable instructions

In some example cases, memory 904a may store software that enables interaction of the user device 102 with server 106. For example, this can include a web browser interface, or the like.

Communication interface 906a is one or more data network interface, such as an IEEE 802.3 or IEEE 802.11 interface, for communication over a network (e.g., network 105).

Display interface 908a can be any suitable display for outputting information and data as needed by various computer programs (e.g., a desktop monitor). In particular, display 908a may display various media streams received from one or more camera systems 104. In some cases, the display interface 908a may include a touchable screen, and may therefore integrate the user input interface 910a.

Input interface 910a can include any interface for receiving user inputs (e.g., user-generated commands), including keyboards and mouses and/or a touchscreen display interface.

Reference is now made to FIG. 9B, which shows a simplified block diagram of an example server 106

Similar to user device 102, server 106 may include one or more processors 902b coupled, via a data bus, to one or more of a memory 904b and a communication interface 906b. Memory 904b and communication interface 906b may be analogous to memory 904a and communication interface 906a.

To this end, it will be understood by those of skill in the art that references herein to the server 106 as carrying out a function or acting in a particular way imply that processor 904b is executing instructions (e.g., a software program) stored in memory 904b and possibly transmitting or receiving inputs and outputs via one or more interface.

In some example cases, memory 904b may store various programs and software that enable the server 106 to perform various methods 400a-400e, and 800a-800b, as described herein. For example, memory 904b can store various animal-specific machine learning detection models.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A method for monitoring and tracking animals in an animal enclosure, comprising:
monitoring for user activity in respect of a camera system associated with the animal enclosure;
if user activity is detected:
receiving a user-generated command to control the camera; and
transmitting the user-generated command to the camera system,
if user activity is not detected, controlling the camera system to search and track for one or more target animals in the animal enclosure.

2. The method of claim 1, wherein controlling the camera system to search and track for the one or more target animals comprises:
controlling the camera system according to a pre-determined scanning pattern;
receiving one or more image frames from the camera system;
applying an animal-specific machine learning detection model to the one or more image frames;
determining whether the target animal was detected in at least one, of the one or more image frames; and
controlling the camera system to focus on the target animal.

3. The method of claim 2, initially, selecting the animal-specific machine learning model based one or more model selection factors.

4. The method of claim 2, further comprising, determining target pixel coordinates for the target animal in the at least on image frame, and determining camera configuration settings for focusing on the target pixel coordinates.

5. The method of claim 1, wherein the user-generated commands include target pixel coordinates, and the method further comprises:
determining camera configuration settings for focusing on the target pixel coordinates; and
transmitting a control signal to the camera system comprising the camera configuration settings.

6. The method of claim 4, wherein the camera configuration settings include one or more of a pan angle, a tilt angle and a zoom angle.

7. The method of claim 1, further comprising, initially:
determining a number of user device connections with the camera system;
determining a pre-defined voting window time period;
opening a voting window for the pre-defined time period;
receiving user-generated commands from each user device;
generating a combined output command based on the user-generated commands.

8. The method of claim 7, wherein the combined output command is generated by determine one of an average and a mean of the target pixel coordinates in each of the user-generated commands.

9. The method of claim 1, wherein the camera system comprises a camera controller coupled to a pan-tilt-zoom (PTZ) camera devices.

10. A system for monitoring and tracking animals in an animal enclosure, the system comprising at least one processor for executing the method of claim 1.
